(19) United States
(12) Patent Application Publication
(10) Pub. No.: US 2025/0133623 A1
(43) Pub. Date: Apr. 24, 2025

(54) UNIFIED TCI FRAMEWORK FOR UL M-TRP

(71) Applicant: QUALCOMM Incorporated, San Diego, CA (US)

(72) Inventors: Fang YUAN, Beijing (CN); Yan ZHOU, San Diego, CA (US); Wooseok NAM, San Diego, CA (US); Tao LUO, San Diego, CA (US)

(21) Appl. No.: 18/695,326

(22) PCT Filed: Nov. 19, 2021
(86) PCT No.: PCT/CN2021/131730

§ 371 Date: Mar. 25, 2024

(51) Int. Cl. H04W 76/20; H04L 5/00; H04W 72/1268; H04W 72/231

(52) U.S. Cl. CPC H04W 76/20; H04L 5/0051; H04W 72/1268; H04W 72/231

(57) ABSTRACT

Methods, apparatuses, and computer readable medium for UL TCI are provided. An example method may include receiving, from a base station, at least one transmission TCI, the at least one TCI indicating a single UL TCI or two UL TCIs. The example method may further include receiving, from the base station, a first SRS resource set and a second SRS resource set for UL MIMO, the first SRS resource set or the second SRS resource set being associated with the at least one TCI. The example method may further include receiving DCI scheduling one or more uplink transmissions associated with at least one of a first TRP or a second TRP. The example method may further include transmitting the one or more uplink transmissions to the base station based on the DCI, the at least one TCI, the first SRS resource set, and the second SRS resource set.

### TECHNICAL FIELD

The present disclosure relates generally to communication systems, and more particularly, to wireless communication systems with transmission configuration indicator (TCI).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a base station, at least one transmission configuration indicator (TCI), the at least one TCI indicating a single uplink (UL) TCI or two UL TCIs. The memory and the at least one processor coupled to the memory may be further configured to receive, from the base station, a first sounding reference signal (SRS) resource set and a second SRS resource set for UL multiple input multiple output (MIMO), the first SRS resource set or the second SRS resource set being associated with the at least one TCI. The memory and the at least one processor coupled to the memory may be further configured to receive downlink control information (DCI) scheduling one or more uplink transmissions associated with at least one of a first transmission reception point (TRP) or a second TRP. The memory and the at least one processor coupled to the memory may be further configured to transmit the one or more uplink transmissions to the base station based on the DCI, the at least one TCI, the first SRS resource set, and the second SRS resource set.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating a base station in communication with a UE via a set of beams.

FIG. 5 is a diagram illustrating example communications between a UE and a base station.

FIGS. 6A and 6B are diagrams illustrating example communications between a UE and a base station.

FIGS. 7A and 7B are diagrams illustrating example communications between a UE and a base station.

FIGS. 8A and 8B are diagrams illustrating example communications between a UE and a base station.

FIG. 9 is a flowchart of a method of wireless communication.

FIG. 10 is a flowchart of a method of wireless communication.

FIG. 11 is a diagram illustrating an example of a hardware implementation for an example apparatus.

### DETAILED DESCRIPTION

In some wireless communication systems, one TCI may be indicated for UL (e.g., indicated by one joint TCI or one UL TCI) and downlink control information (DCI) may be configured with fields for multiple transmission reception point (TRP) (M-TRP). Example aspects provided herein may provide a framework for applying TCIs for UL M-TRP transmissions or single TRP (S-TRP) transmissions, such as physical uplink shared channel (PUSCH) or physical uplink control channel (PUCCH) to improve efficiency of communication between a UE and a base station.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

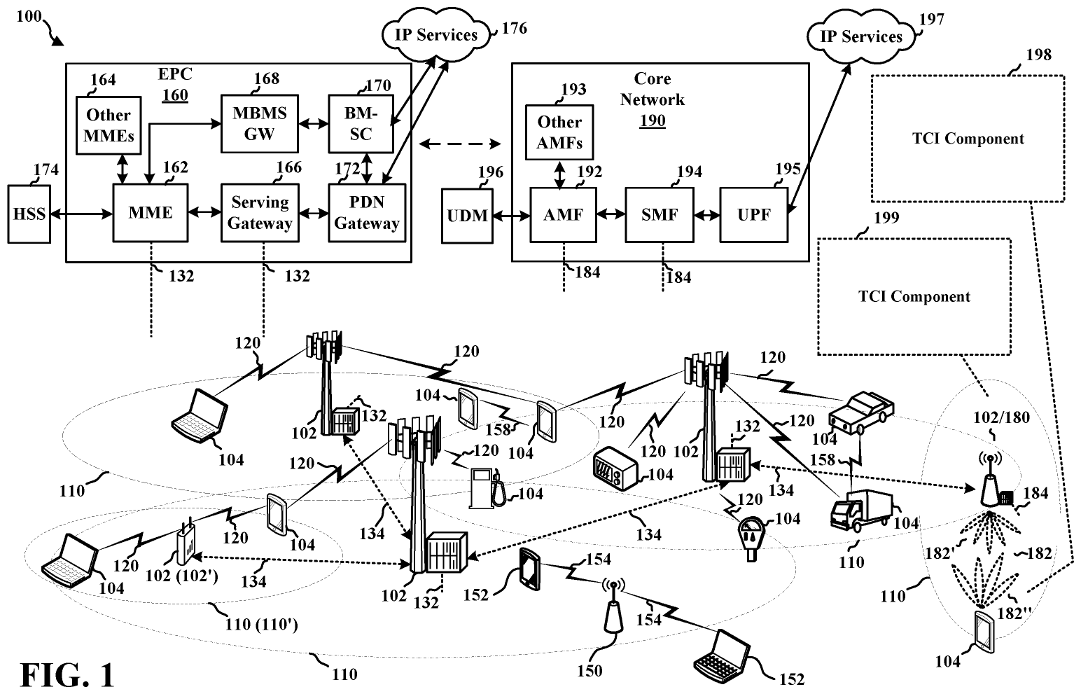

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (Pcell) and a secondary component carrier may be referred to as a secondary cell (Scell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a TCI component 198. In some aspects, the TCI component 198 may be configured to receive, from a base station, at least one TCI, the at least one TCI indicating a single UL TCI or two UL TCIs. In some aspects, the TCI component 198 may be further configured to receive, from the base station, a first SRS resource set and a second SRS resource set for UL MIMO, the first SRS resource set or the second SRS resource set being associated with the at least one TCI. In some aspects, the TCI component 198 may be further configured to receive DCI scheduling one or more uplink transmissions associated with at least one of a first TRP or a second TRP. In some aspects, the TCI component 198 may be further configured to transmit the one or more uplink transmissions to the base station based on the DCI, the at least one TCI, the first SRS resource set, and the second SRS resource set.

Although the following description may be focused on 5G NR, the concepts described herein may be applicable to other similar areas, such as LTE, LTE-A, CDMA, GSM, and other wireless technologies.

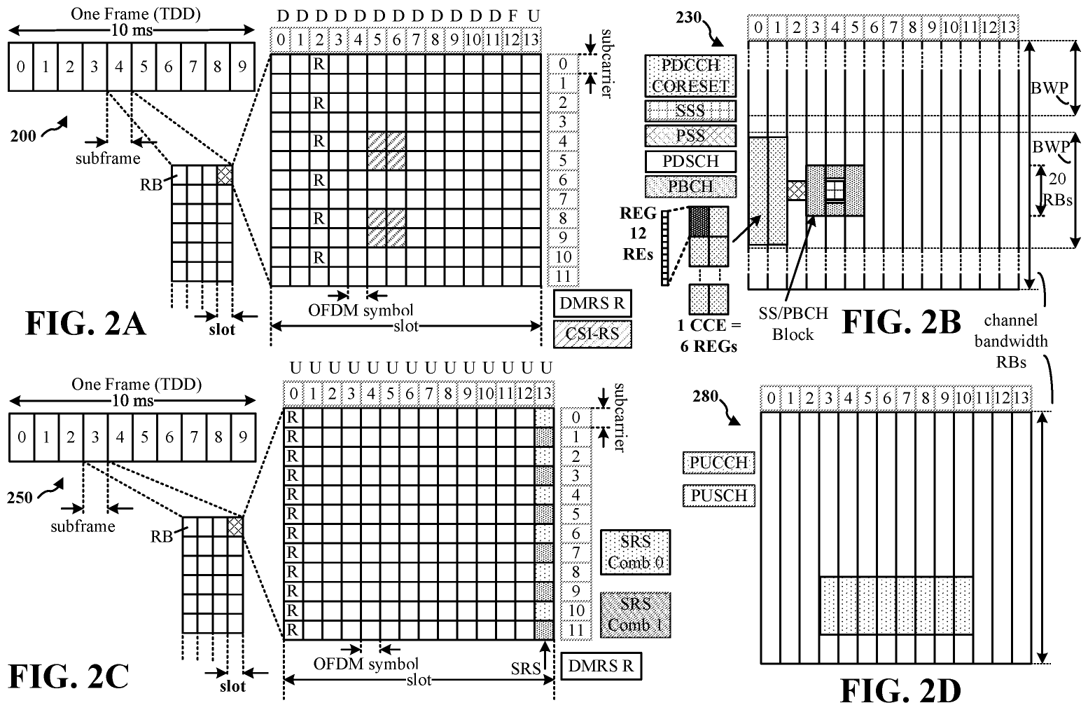

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

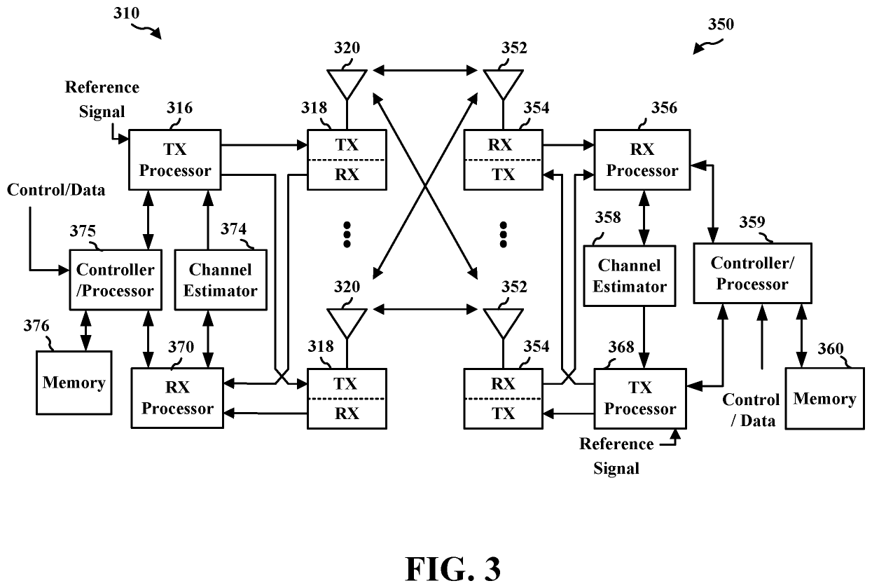

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with TCI component 198 of FIG. 1.

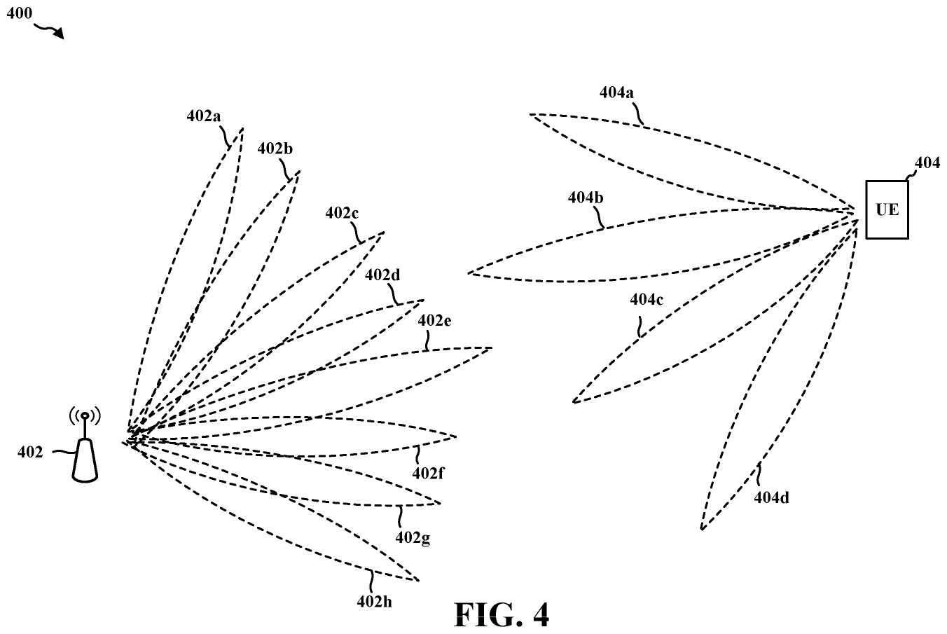

FIG. 4 is a diagram 400 illustrating a base station 402 in communication with a UE 404. Referring to FIG. 4, the base station 402 may transmit a beamformed signal to the UE 404 in one or more of the directions 402a, 402b, 402c, 402d, 402e, 402f, 402g, 402h. The UE 404 may receive the beamformed signal from the base station 402 in one or more receive directions 404a, 404b, 404c, 404d. The UE 404 may also transmit a beamformed signal to the base station 402 in one or more of the directions 404a-504d. The base station 402 may receive the beamformed signal from the UE 404 in one or more of the receive directions 402a-502h. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same. The term beam may be otherwise referred to as “spatial filter”. Beamforming may be otherwise referred to as “spatial filtering”.

In response to different conditions, the UE 404 may determine to switch beams, e.g., between beams 402a-502h. The beam at the UE 404 may be used for reception of downlink communication and/or transmission of uplink communication. In some examples, the base station 402 may send a transmission that triggers a beam switch by the UE 404. A TCI state may include Quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the base station 402 may indicate a TCI state change, and in response, the UE 404 may switch to a new beam (which may be otherwise referred to as performing a beam switch) according to the new TCI state indicated by the base station 402.

In some wireless communication systems, such as a wireless communication system under a unified TCI framework, a pool of joint DL/UL TCI states may be used for joint DL/UL TCI state updates for beam indication. For example, the base station 402 may transmit a pool of joint DL/UL TCI states to the UE 404. The UE 404 may determine to switch transmission beams and/or reception beams based on the joint DL/UL TCI states. In some aspects, the TCI state pool for separate DL and UL TCI state updates may be used. In some aspects, the base station 402 may use RRC signaling to configure the TCI state pool. In some aspects, the joint TCI may or may not include UL specific parameter(s) such as UL PC/timing parameters, PLRS, panel-related indication, or the like. If the joint TCI includes the UL specific parameter(s), the parameters may be used for the UL transmission of the DL and UL transmissions to which the joint TCI is applied.

Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 4 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like.

A TCI state may be defined to represent at least one source RS to provide a reference (e.g., UE assumption) for determining quasi-co-location (QCL) or spatial filters. For example, a TCI state may define a QCL assumption between a source RS and a target RS.

To accommodate situations where beam indication for UL and DL are separate, two separate TCI states (one for DL and another one for UL) may be utilized. For a separate DL TCI, the source reference signal(s) in M (M being an integer) TCIs may provide QCL information at least for UE-dedicated reception on PDSCH and for UE-dedicated reception on all or subset of CORESETs in a CC. For a separate UL TCI, the source reference signal(s) in N (N being an integer) TCIs provide a reference for determining common UL transmission (TX) spatial filter(s) at least for dynamic-grant or configured-grant based PUSCH and all or subset of dedicated PUCCH resources in a CC.

In some aspects, the UL TX spatial filter may also apply to all SRS resources in resource set(s) configured for antenna switching, codebook-based (CB), or non-codebook-based (NCB) UL transmissions.

In some aspects, each of the following DL RSs may share the same indicated TCI state as UE-dedicated reception on PDSCH and for UE-dedicated reception on all or subset of CORESETs in a CC: CSI-RS resources for CSI, some or all CSI-RS resources for beam management, CSI-RS for tracking, and DM-RS(s) associated with UE-dedicated reception on PDSCH and all/subset of CORESETs. Some SRS resources or resource sets for beam management may share the same indicated TCI state as dynamic-grant/configured-grant based PUSCH, all or subset of dedicated PUCCH resources in a CC. In some wireless communication systems, several QCL rules may be defined. For example, a first rule may define that TCI to DM-RS of UE dedicated PDSCH and PDCCH may not have SSB as a source RS to provide QCL type D information. A second rule may define that TCI to some DL RS such as CSI-RS may have SSB as a source RS to provide QCL type D information. A third rule may define that TCI to some UL RS such as SRS can have SSB as a source RS to provide spatial filter information. Example aspects provided herein enable a UE to signal capability of applying unified TCI to RS, provide QCL indication to DL RS, and provide hybrid spatial filter indication to UL RS.

In some wireless communication systems, to facilitate a common TCI state ID update and activation to provide common QCL information at least for UE-dedicated PDCCH/PDSCH (e.g., common to UE-dedicated PDCCH and UE-dedicated PDSCH) or common UL TX spatial filter(s) at least for UE-dedicated PUSCH/PUCCH across a set of configured CCs/BWPs (e.g., common to multiple PUSCH/PUCCH across configured CCs/BWPs), several configurations may be provided. For example, the RRC-configured TCI state pool(s) may be configured as part of the PDSCH configuration (such as in a PDSCH-Config parameter) for each BWP or CC. The RRC-configured TCI state pool(s) may be absent in the PDSCH configuration for each BWP/CC, and may be replaced with a reference to RRC-configured TCI state pool(s) in a reference BWP/CC. For a BWP/CC where the PDSCH configuration contains a reference to the RRC-configured TCI state pool(s) in a reference BWP/CC, the UE may apply the RRC-configured TCI state pool(s) in the reference BWP/CC. When the BWP/CC identifier (ID) (e.g., for a cell) for QCL-Type A or Type D source RS in a QCL information (such as in a QCL info parameter) of the TCI state is absent, the UE may assume that QCL-Type A or Type D source RS is in the BWP/CC to which the TCI state applies. In addition, a UE may report a UE capability indicating a maximum number of TCI state pools that the UE can support across BWPs and CCs in a band.

Before receiving a TCI state, a UE may assume that the antenna ports of one DM-RS port group of a PDSCH are spatially quasi-colocated (QCLed) with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCLed with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). In some aspects, a maximum number of TCI states may be 128.

In some aspects, a UE may receive a signal, from a base station, configured to trigger a TCI state change via, for example, a medium access control (MAC) control element (CE) (MAC-CE), a downlink control information (DCI), or a radio resource control (RRC) signal. The TCI state change may cause the UE to find the best or most suitable UE receive beam corresponding to the TCI state indicated by the base station, and switch to such beam. Switching beams may allow for an enhanced or improved connection between the UE and the base station by ensuring that the transmitter and receiver use the same configured set of beams for communication.

In some aspects, a spatial relation change, such as a spatial relation update, may trigger the UE to switch beams. Beamforming may be applied to uplink channels, such as a PUSCH, a PUCCH, or an SRS, or downlink channels, such as PDCCH, PDSCH, or the like. Beamforming may be based on configuring one or more spatial relations between the uplink and downlink signals. Spatial relation indicates that a UE may transmit the uplink signal using the same beam used for receiving the corresponding downlink signal.

In some wireless communication systems, joint TCI for DL and UL may be supported. The source reference signal(s) in M (M being a positive integer) TCIs may provide common QCL information at least for UE-dedicated reception on PDSCH and all or subset of control resource sets (CORESETs) in a component carrier (CC). The source reference signal(s) in N (N being a positive integer) TCIs may provide a reference for determining common UL TX spatial filter(s) at least for dynamic-grant/configured-grant based PUSCH, all or subset of dedicated PUCCH resources in a CC. The UL TX spatial filter may also apply to all SRS resources in resource set(s) configured for antenna switching, codebook-based, or non-codebook-based UL transmissions.

In some wireless communication systems, two separate TCI states, one for DL and one for UL, may be used. For the separate DL TCI, the source reference signal(s) in M TCIs may provide QCL information at least for UE-dedicated reception on PDSCH and for UE-dedicated reception on all or subset of CORESETs in a CC. For the separate UL TCI, the source reference signal(s) in N TCIs may provide a reference for determining common UL TX spatial filter(s) at least for dynamic-grant/configured-grant based PUSCH, all or subset of dedicated PUCCH resources in a CC. The UL TX spatial filter can also apply to all SRS resources in resource set(s) configured for antenna switching, codebook-based, or non-codebook-based UL transmissions.

In some wireless communication systems, M equal to 1 and N equal to 1 (which may be denoted by (M,N)=(1,1) and may represent M=1 DL TCI for DL receptions and N=1 UL TCI for the UL transmissions or may represent one joint TCI for both DL and UL. In some wireless communications, (M,N)=(2,1), (1,2), and (2,2) for M-TRP and some S-TRP use cases may be further supported.

A wireless device may include M-TRP. Each TRP may include different RF modules having a shared hardware and/or software controller. Each TRP may have separate RF and digital processing. Each TRP may also perform separate baseband processing. Each TRP may include a different antenna panel or a different set of antenna elements of a wireless device. The TRPs of the wireless device may be physically separated. For example, TRPs on a wireless device of a vehicle may be located at different locations of the vehicle. Front and rear antenna panels on a vehicle may be separated by 3 meters, 4 meters, or the like. The spacing between TRPs may vary based on the size of a vehicle and/or the number of TRPs associated with the vehicle. Each of the TRPs may experience a channel differently (e.g., experience a different channel quality) due to the difference physical location, the distance between the TRPs, different line-of-sight (LOS) characteristics (e.g., a LOS channel in comparison to a non-LOS (NLOS) channel), blocking/obstructions, interference from other transmissions, among other reasons.

As one example, for (M,N)=(2,2), both joint and separate DL/UL TCI may be supported. For example, (M,N)=(2,2) may mean two joint TCIs, where each joint TCI may indicate one QCL information for DL receptions and one spatial transmit filter for UL transmissions. For another example, (M,N)=(2,2) may mean two pairs of DL TCI and UL TCI, where each DL TCI may indicate one QCL information for DL receptions and each UL TCI may indicate one spatial transmit filter for UL transmissions. Supporting more than one DL or UL TCI may not be correlated with supporting simultaneous transmission (2,2) may include, by way of example, CORESET beam diversity, inter-cell beam management, multiple panels UE (MP-UE), inter-band carrier aggregation (CA), or the like, across multiple panels (STxMP). The S-TRP use cases with (M,N)=(2,1), (1,2), and

Aspects provided herein may provide support mechanisms for M>1 and N>1 in a single TCI indication signalling. For joint TCI, the indicated TCI(s) may be (M,N)=(1,1) or (2,2), i.e., one joint TCI may indicate one QCL information for DL receptions and one spatial transmit filter for UL transmissions, or indicate two joint TCIs for different channels in DL receptions and UL transmissions. For separate DL/UL TCI, the indicated TCI(s) may be (M,N)=(1,1), (2,2), (1,2) or (2,1). For separate DL/UL TCI with (M,N)=(1,1), one pair of DL TCI and UL TCI may be indicated. For separate DL/UL TCI with (M,N)=(2,2), two pairs of DL TCI and UL TCI may be indicated. For separate DL/UL TCI with (M,N)=(1,2), one DL TCI and two UL TCIs may be indicated. For separate DL/UL TCI with (M,N)=(2,1), two DL TCIs and one UL TCI may be indicated. The single TCI indication indicating one or more TCIs with M>1 and N>1 may be a DCI with a TCI indication field, or a MAC-CE. For example, the codepoint of TCI indication field in DCI may provide a single TCI indication with (M,N).

DCI format 0_1 or 0_2 scheduling M-TRP may include a dynamic switching field. For example, as illustrated in the table below:

TABLE 2

| Codepoint in | | |
|---|---|---|
| DCI 0_1 or | | SRI (for both CB and |
| 0_2 | SRS resource set(s) | NCB)/TPMI (CB only) field(s) |
| 00 | s-TRP mode with 1^{st} SRS | 1^{st} SRI/TPMI field (2^{nd} field is |
| | resource set (TRP 1) | unused) |
| 01 | s-TRP mode with 2^{nd} SRS | 1^{st} SRI/TPMI field (2^{nd} field is |
| | resource set (TRP 2) | unused) |
| 10 | m-TRP mode with (TRP | Both 1^{st} and 2^{nd} SRI/TPMI fields |
| | 1, TRP 2 order) | |
| | 1^{st} Service Request Indicator | |
| | (SRI)/Transmitted Precoding | |
| | Matrix Indicator (TPMI) field: | |
| | 1^{st} SRS resource set | |
| | 2^{nd} SRI/TPMI field: 2^{nd} SRS | |
| | resource set | |
| 11 | m-TRP mode with (TRP | Both 1st and 2nd SRI/TPMI |
| | 2, TRP 1 order) | fields |
| | 1st SRI/TPMI field: 1^{st} SRS | |
| | resource set | |
| | 2nd SRI/TPMI field: 2nd SRS | |
| | resource set | |

Some wireless communication systems may use codebook-based MIMO. MIMO systems may allow multiple independent radio terminals, each of which has one or multiple antennas that communicate with a given access point in such a way that each radio terminal can fully utilize all the spectral resources simultaneously. A MIMO system (such as the base station 402) may employ a procedure, such as precoding, to resolve the problem of interference among the signals transmitted from an access point to the multiple terminals in the same frequency band at the same time.

In codebook-based MIMO wireless communication systems, the precoding may be selected from a standardized codebook. In a non-codebook-based MIMO, there may be no such codebook, and the precoding may be dynamically determined. For some non-codebook-based MIMO in a PUSCH, an SRI field in DCI may indicate a set of precoders associated with an SRS resource set and a set of power control (PC) parameters which may include any of P0, alpha, closed-loop index (which may be referred to as “Closedloopindex”), PL RS, or the like. P0 may represent a SINR target for the power control. Alpha may represent possible values for uplink power control (e.g., pathloss compensation factor). The closed-loop index may be an index of the closed power control loop associated with the SRI and the associated PUSCH. A beam of the PUSCH may follow the SRS resource set. For example, all SRSs in the same SRS resource set may have the same beam, and the SRI may not select a beam.

For some codebook-based MIMO in a PUSCH, an SRI field in DCI may select an SRS resource from multiple SRSs in an SRS resource set for determining a beam for PUSCH transmission. For example, different SRS selected by SRI in the SRS resource set may have different beams. A transmitted precoding matrix indicator (TPMI) in DCI may indicate precoders, and the SRI field may indicate a set of power control parameters which may also include any of P0, alpha, Closedloopindex, PL RS, or the like.

For PC parameters that are not PL RS (e.g., P0, alpha, and closedloopindex), for each of PUSCH, PUCCH, and SRS, one or more of the following settings may be selected or combined: 1) the setting of (P0, alpha, closed-loop index) may be associated with UL or (if applicable) joint TCI state; 2) the setting of (P0, alpha, closed-loop index) may be included with UL or (if applicable) joint TCI state; and 3) the setting of (P0, alpha, closed-loop index) may be neither associated with nor included in UL or (if applicable) joint TCI state. The setting of (P0, alpha, closed-loop index) may be associated with the UL channel or UL RS. Therefore, the setting of PC parameters that are not PL RS may be channel-specific and signal-specific. PL RS settings may be configured differently. For example, PL RS may be included in UL TCI state (or, if applicable, joint TCI state). If not included in the UL TCI state, PL RS may be the periodic DL-RS used as a source RS for determining spatial TX filter or the PL RS used for the UL RS in UL or (if applicable) joint TCI state. PL-RS may also be associated with (but not included in) UL TCI state (or, if applicable, joint TCI state). If not associated with the UL TCI state, PL RS may be the periodic DL-RS used as a source RS for determining spatial TX filter or the PL RS used for the UL RS in UL or (if applicable) joint TCI state. A UE may also calculate path-loss based on periodic DL RS configured as the source RS for determining spatial TX filter in UL or (if applicable) joint TCI state. In some aspects, if a PL RS is not included in or associated with the UL TCI state (or, if applicable, joint TCI state), the UE may estimate path-loss based on the PL-RS of an UL RS provided in an UL TCI state (or, if applicable, joint TCI state) as a source RS for determining the spatial TX filter. In some aspects, if a PL RS is not included in or associated with the UL TCI state (or, if applicable, joint TCI state), the UE may not estimate path-loss based on the PL-RS of an UL RS provided in an UL TCI state (or, if applicable, joint TCI state) as a source RS for determining the spatial TX filter. In some aspects, a UE may calculate path-loss based on periodic DL RS configured as the source RS or a periodic QCL-Type-D/spatialRelationInfo source of the source RS in UL TCI state or (if applicable) joint TCI state.

In some wireless communication systems, for each of PUSCH and PUCCH, the setting of (P0, alpha, closed loop index) may be associated with UL or (if applicable) joint TCI state per BWP. In some aspects, multiple settings are configured. In some aspects, each setting may be associated with at least one TCI state, and, for a given TCI state, no more than one setting for PUSCH and no more than one setting for PUCCH may be associated at a time. In some aspects, for each of the PUSCH and PUCCH, each of the activated UL or (if applicable) joint TCI states is associated with one of the settings. In some aspects, if not associated, for each of the PUSCH and PUCCH, the setting(s) of (P0, alpha, closed loop index) per channel/signal per BWP may be independent of the UL or (if applicable) joint TCI states.

In some aspects, the setting of (P0, alpha, closed loop index) for SRS may be or may not be associated with UL or (if applicable) joint TCI state. In some aspects, the same setting of (P0, alpha, closed loop index) per TCI state may be configured across channels and may be applied with a channel dependent component, or configured a channel dependent setting of (P0, alpha, closed loop index) per TCI state.

In some wireless communication systems, no more than one transmit power control (TPC) field may be used even for a DCI configured with a second TPC field. For per-TRP closed-loop power control, when the second TPC field is configured and the indicated PUCCH transmission in DCI formats 1_1/1_2 (or PUSCH transmission in DCI formats 0_1/0_2) is associated with one “closedLoopIndex” value for single TRP transmission, the other TPC field associated with the other “closedLoopIndex” value may be unused. Each TPC field may be for each closed-loop index value respectively (i.e., 1^{st}/2^{nd} TPC fields correspond to “closedLoopIndex” value=0 and 1, respectively).

In some wireless communication systems, for M-TRP PUCCH (or PUSCH) repetitions schemes. When the second TPC field is configured and the indicated PUCCH transmission in DCI formats 1_1/1_2 (or PUSCH transmission in DCI formats 0_1/0_2) is associated with the same “closedLoopIndex” value for M-TRP transmission, the other TPC field associated with the other “closedLoopIndex” value may be unused.

In some wireless communication systems, a single TCI may be indicated for UL, for example, a TCI codepoint with joint TCI (M,N)=(1,1) or separate TCI (M,N)=(1,1), (2,1) in the TCI field of DCI, while DCI may be configured with fields for M-TRP. When UE is indicated with a TCI codepoint of joint TCI with (M,N)=(1, 1), or separate TCI(s) with (M,N)=(1,1) or (2,1), the UE may apply the single indicated TCI for UE-dedicated PUCCH and PUSCH if the UE is configured with S-TRP operation without M-TRP operation. However, the UE may be configured with M-TRP operation in UL and RRC may configure to enable per-TRP precoding for M-TRP operation in UL. For example, two SRS resource sets for UL MIMO, either NCB or CB, may be configured. As another example, two SRI/TPMI fields for UL MIMO in DCI 0_1 or DCI 0_2 may also be configured. RRC may configure a set of PC parameters (including Po, Alpha, ClosedLoopIndex) per-TCI per UL channel to enable per-TRP power control. For example, two TPC fields in DCI 1_1/1_2 for PUCCH, or in DCI 0_1/0_2 for PUSCH, may be used. Example M-TRP operations may be based on time division multiplexing (TDM), frequency division multiplexing (FDM), space division multiplexing (SDM), or single frequency network (SFN). In another example, joint TCI (M,N)=(2,2) or separate TCI (M,N)=(1,2), (2,2). When at least one of the activated TCI codepoint has joint TCI with (M,N)=(2,2), or separate TCI with (M,N)=(1,2), (2,2), a UE may expect the RRC to configure two SRS resource sets for UL MIMO, either NCB or CB and two SRI/TPMI fields for UL MIMO in DCI 0_1/DCI 0_2. RRC may configure a set of PC parameters (including Po, Alpha, ClosedLoopIndex) per-TCI per UL channel to enable per-TRP power control. Two TPC fields in DCI 1_1/1_2 for PUCCH, or in DCI 0_1/0_2 for PUSCH may be used.

Some example aspects provided herein provide mechanisms that enables operations when a single TCI is indicated for UL, and DCI is configured with fields for M-TRP. Some example aspects provided herein may provide mechanisms for operations where two TCIs are indicated in a TCI codepoint for UL.

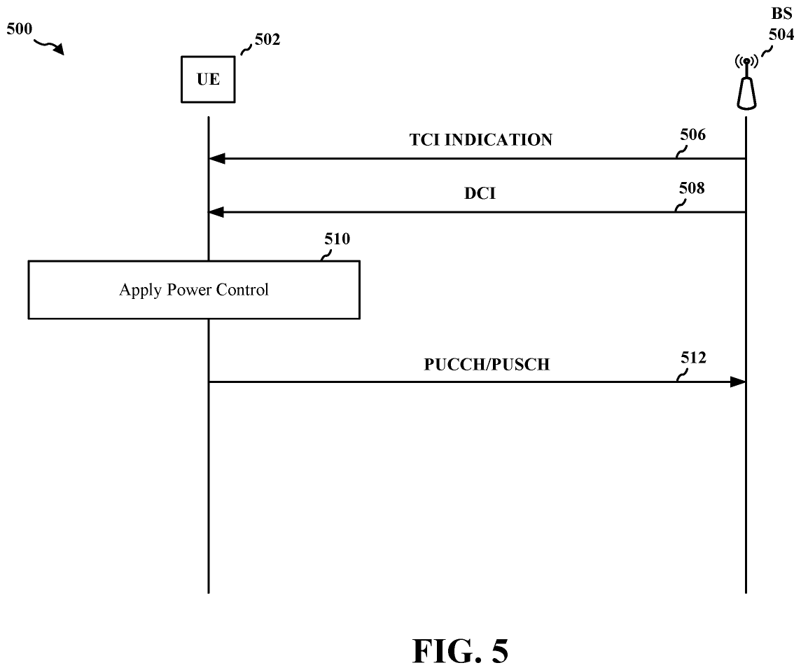

FIG. 5 is a diagram 500 illustrating example communications between a UE 502 and a base station 504. As illustrated in FIG. 5, the base station 504 may transmit TCI indication 506 in the form of joint TCI or separate DL/UL TCI to the UE 502. In some aspects, the base station 504 may also transmit DCI 508 for M-TRP or S-TRP operations to the UE 502. The UE 502 may be configured with more than one SRS resource sets for UL MIMO, such as CB or NCB MIMO. In some aspects, the UE 502 may apply PC parameters indicated by the TCI indication 506 or the DCI 508 at 510. The UE 502 may also transmit PUCCH or PUSCH 512 based on the indicated TCI in the TCI indication 506 and the DCI 508.

In some aspects, if the UE 502 is configured with two SRS resource sets for UL MIMO, either for NCB MIMO or for CB MIMO, when UE is indicated with a TCI codepoint of joint TCI with (M,N)=(1, 1), or separate TCI(s) with (M,N)=(1,1) or (2,1), the UE 502 may apply the single indicated TCI to both SRS resource sets. For example, the UE 502 may support a DCI 0_1 or 0_2 with a dynamic switching field indicating “00” or “01” for a S-TRP PUSCH transmission (e.g., the PUSCH 512). The dynamic switching field in DCI (e.g., the DCI 508) may select one of two SRS resource sets and the corresponding precoders to be used for the scheduled PUSCH (e.g., the PUSCH 512). In some aspects, the UE 502 may additionally support a DCI 0_1 or 02 with a dynamic switching field indicating “10” or “11” for a M-TRP PUSCH transmission. The DCI (e.g., the DCI 508) may use two SRI/TPMI fields to indicate two precoders for the PUSCH with precoder cycling. In some aspects, when DCI 0_1/0_2 is not configured with a dynamic switching field, the UE 502 may apply a default SRS scheme, such as a default SRS resource set of the two SRS resource set or using both SRS resource sets by default to be used. In some aspects, the UE 502 may UE apply the single indicated TCI to one associated SRS resource set. In some aspects, radio resource control (RRC) or medium access control (MAC) control element (MAC-CE)) may (e.g., may be used by a base station to) associate a TCI with one of two SRS resource sets (e.g., based on closed loop index), and the indicated TCI selects the SRS resource set to be used. In some aspects, the UE 502 may suspend the transmission of the other SRS resource set not associated by the indicated TCI. In some aspects, S-TRP PUSCH may be scheduled and M-TRP PUSCH may not be scheduled. If DCI 0_1/0_2 is configured with a dynamic switching field, the UE 502 may expect the dynamic switching field selecting the same SRS resource set as the one indicated by TCI.

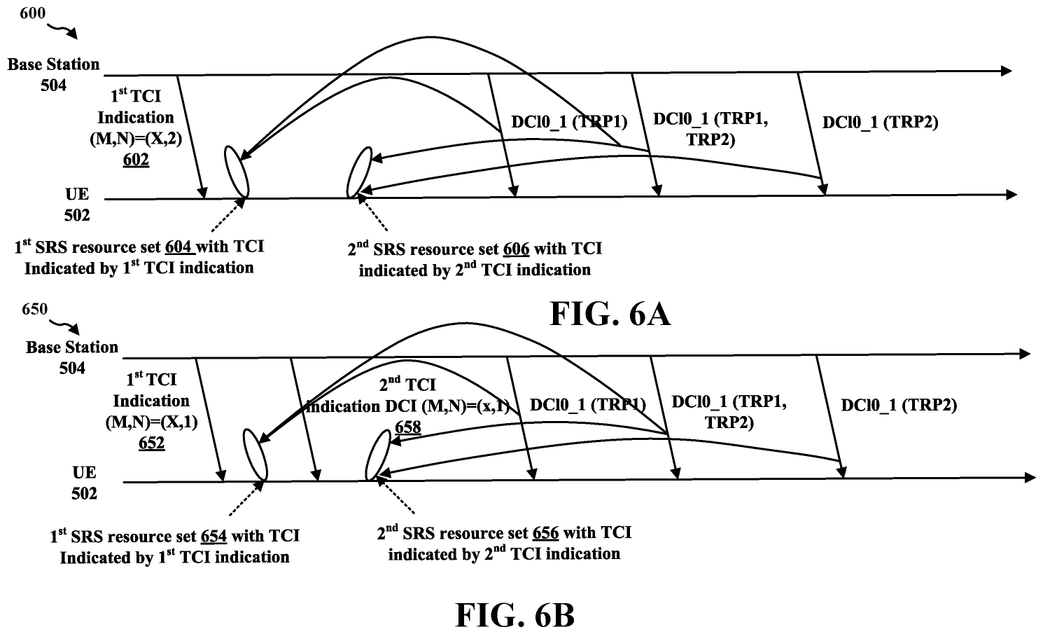

FIGS. 6A and 6B are diagrams 600 and 650 illustrating example communications between a UE and a base station. As illustrated in FIG. 6A, the base station 504 may transmit a first TCI indication (M,N)=(X,2) 602 which may be two joint TCIs or two pairs of DL TCI and UL TCI to the UE 502, and the first TCI Indication 602 may indicate two spatial transmit filters through two joint TCIs or two UL TCIs for the transmission of a first SRS resource set 604 and a second SRS resource set 606 respectively. For M-TRP PUSCH transmission, the TRP1 may be associated with the first SRS resource set, and the TRP 2 may be associated with the second SRS resource set, and DCI may apply the dynamic switching field to schedule PUSCH transmission for different TPRs. The first DCI 0_1 may schedule a PUSCH transmission for TRP 1 which is associated with the first SRS resource set, a second DCI 0_1 may schedule a PUSCH transmission for TRP 1 associated with the first SRS resource set and TRP 2 associated with the second SRS resource set, a third DCI 0_1 may schedule a PUSCH transmission for TRP 2 associated with the second SRS resource set.

As illustrated in FIG. 6B, the base station 504 may transmit a first TCI Indication (M,N)=(X,1) 652 to the UE 502 and the first TCI indication 652 may indicate a 1^{st} UL TCI or a 1^{st} joint TCI to a first SRS resource set 654, and the base station 504 may transmit a second TCI Indication (M,N)=(X,1) 658 to the UE 502 and the second TCI indication may indicate a 2^{nd} UL TCI or a 2^{nd} joint TCI to a second SRS resource set 656. The first DCI 0_1 may schedule a PUSCH transmission for TRP 1 which is associated with the first SRS resource set, a second DCI 0_1 may schedule a PUSCH transmission for TRP 1 associated with the first SRS resource set and TRP 2 associated with the second SRS resource set, a third DCI 0_1 may schedule a PUSCH transmission for TRP 2 associated with the second SRS resource set.

In some aspects, the UE 502 may apply the single indicated TCI to one associated SRS resource set. The UE 502 may receive two TCI indication DCIs indicating a single TCI to two SRS resource sets. In some aspects, RRC or MAC-CE may associate a TCI with one of two SRS resource sets (e.g., based on closed loop index), and the indicated TCI may be applied to the associated SRS resource set. In some aspects, none of SRS transmission is suspended by the UE 502. In some aspects, the dynamic switching field in DCI 0_1/DCI 0_2, if configured, may determine the number of SRS resource sets, and/or the TRP order to be used for the scheduled PUSCH (e.g., PUSCH 512). In some aspects, both S-TRP PUSCH and M-TRP PUSCH may be scheduled (e.g., as part of PUSCH 512), after two TCI indications take effect.

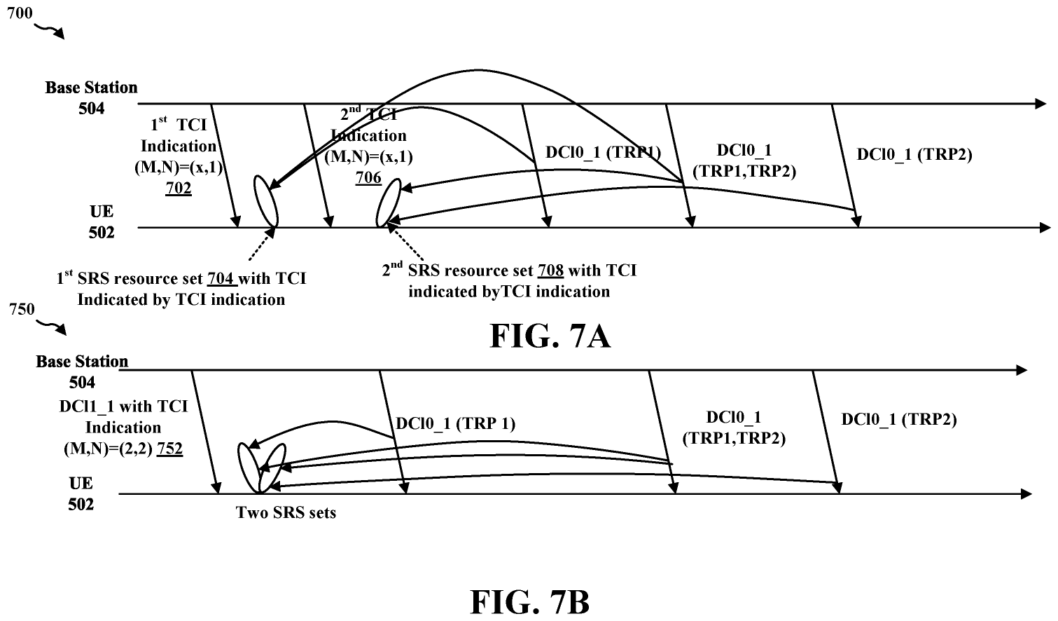

FIG. 7A is a diagrams 700 illustrating example communications between the UE 502 and the base station 504. As illustrated in FIG. 7A, the base station 504 may transmit a first TCI Indication (M,N)=(X,1) 702 to the UE 502 and the first TCI Indication 702 may indicate a first joint TCI or a first UL TCI to a first SRS resource set 704. The first SRS resource set may be selected by DCI 0_1 for TRP 1 and DCI 0_1 for TRP 1 and TRP 2. The base station 504 may transmit a second TCI Indication (M,N)=(X,1) 706 to the UE 502 and the second TCI indication 706 may indicate a second joint TCI or a second UL TCI to a second SRS resource set 708. The second SRS resource set 706 may be selected by DCI 0_1 for TRP 2 and DCI 0_1 for TRP 1 and TRP 2. The first DCI 0_1 may schedule a PUSCH transmission for TRP 1 which is associated with the first SRS resource set, a second DCI 0_1 may schedule a PUSCH transmission for TRP 1 associated with the first SRS resource set and TRP 2 associated with the second SRS resource set, a third DCI 0_1 may schedule a PUSCH transmission for TRP 2 associated with the second SRS resource set.

In some aspects, the UE 502 may apply no more than one single indicated TCI for UE-dedicated PUSCHs. In some aspects, the UE 502 may apply one or two TCI indications of single TCI for UE-dedicated PUSCHs, after two TCI indications take effect. In some aspects, a DCI 0_1/0_2 with a dynamic switching field indicating “00” or “01” for a S-TRP PUSCH transmission may determine the SRS resource set and the TCI indication to be used. In some aspects, a DCI 0_1/0_2 with a dynamic switching field indicating “10” or “11” for a M-TRP PUSCH transmission may determine the order of SRS resource sets and the order of TCI indications to be used. In some aspects, a DCI not configured with a dynamic switching field may be applied with a default scheme for an SRS resource set and/or a default TCI indication to be used.

In some aspects, if the setting of PC parameters is associated with a TCI for PUSCH (e.g., the PUSCH 512), when the UE 5-2 is indicated with a TCI codepoint of joint TCI with (M,N)=(1, 1), or separate TCI(s) with (M,N)=(1,1) or (2,1), the UE 502 may apply the set of PC parameters associated with the indicated unified TCI for UE-dedicated PUSCHs. For example, when UE determines to apply a single indicated TCI for UE-dedicated PUSCHs, based on TCI indication DCI and/or dynamic switching field in DL), for DCI 0_1/0_2 configured with two TPC fields, no more than one TPC field may be used. For example, the TPC field for a “closedLoopIndex” value associated with the indicated TCI may be used for the PUSCH, and the other TPC field associated with the other “closedLoopIndex” value may be unused.

In some aspects, when the UE 502 determines to apply the single indicated TCI to one associated SRS resource set, based on TCI indication DCI and/or dynamic switching field in DL), the UE 502 may apply two TCI indications of single TCI for UE-dedicated M-TRP PUSCHs, e.g., if DCI 0_1/0_2 is configured with two TPC fields, and if two indicated TCIs are associated with different “closedLoopIndex” values, two TPC fields may be used for different TRPs in the PUSCH (e.g., the PUSCH 512).

In some aspects, if DCI 0_1/0_2 is configured with two TPC fields, and if two indicated TCIs are associated with one “closedLoopIndex” value, the TPC field for the “closedLoopIndex” value may be used for the PUSCH, and the other TPC field associated with the other “closedLoopIndex” value is unused. In some aspects, if DCI 0_1/0_2 is configured with a single TPC field, the TPC field may be used for close loop indices of the PUSCH (e.g., the PUSCH 512).

In some aspects, when the UE 502 is indicated with a TCI codepoint of joint TCI with (M,N)=(1, 1), or separate TCI(s) with (M,N)=(1,1) or (2,1), the UE 502 may apply the single indicated TCI for UE-dedicated PUCCHs. If the setting of PC parameters is associated with a TCI for a PUCCH, the UE 502 may apply the set of PC parameters associated with the indicated TCI for UE-dedicated PUCCHs. For example, for DCI 1_1/1_2 configured with two TPC fields, no more than one TPC field may be used. The TPC field for a “closedLoopIndex” value associated with the indicated TCI may be used for the PUCCH, and the other TPC field associated with the other “closedLoopIndex” value may be unused. In some aspects, if a unified TCI is indicated to a subset of PUCCHs without anything else, the PRI field in DCI may determine the PUCCH subset, and the latest TCI indication DCI applicable to the subset of PUCCH may provide the value “closedloopindex. In some aspects, if a unified TCI is indicated to all PUCCHs without anything else, the latest TCI indication DCI applicable to the PUCCH may provide the value “closedloopindex”. In some aspects, if all TCI codepoints are activated with a single TCI, no more than one TPC field may be used for PUCCH.

In some aspects, if DCI is configured with two TPC fields (DCI 0_1/0_2 for PUSCH, or DCI 1_1/1_2 for PUCCH) and the setting of PC parameters are associated with a TCI for a UL channel, the UE 502 may be indicated with a TCI codepoint of joint TCI with (M,N)=(2, 2), or separate TCI(s) with (M,N)=(1,2) or (2,2). In some aspects, if two TCIs in the indicated TCI codepoint are associated with the same “closedloopindex” value, the UE 502 may use no more than one TPC field corresponding to the “closedloopindex” value in DCI after the TCI indication takes effect, and the other TPC field associated with the other “closedLoopIndex” value is unused.

In some aspects, if the UE 502 is configured with two SRS resource sets for UL MIMO, either for NCB MIMO or for CB MIMO, when the UE 502 is indicated with a TCI codepoint of joint TCI with (M,N)=(2, 2), or separate TCI(s) with (M,N)=(1,2) or (2,2), the UE 502 may apply two indicated TCIs to first SRS resource set and second SRS resource set respectively.

In some aspects, if the UE 502 is configured with two SRS resource sets for UL MIMO, either for NCB MIMO or for CB MIMO, when the UE 502 is indicated with a TCI codepoint of joint TCI with (M,N)=(2, 2), or separate TCI(s) with (M,N)=(1,2) or (2,2), the UE 502 may apply two indicated TCIs to first SRS resource set and second SRS resource set respectively. In some aspects, S-TRP or M-TRP operation may be switched by the dynamic switching field in DCI 0_1/0_2. In some aspects, a DCI 0_1/0_2 with a dynamic switching field “00” or “01” may indicate a S-TRP PUSCH transmission and may determine one of two SRS resource sets and the corresponding TCI to be used. In some aspects, a DCI 0_1/0_2 with a dynamic switching field “10” or “11” may indicate a M-TRP PUSCH transmission and determines the order of SRS resource sets and the order of TCIs to be used. In some aspects, a DCI 0_0 may schedule a S-TRP PUSCH transmission. The TCI with the lowest ID in the pair of indicated TCIs may be used.

FIG. 7B is a diagrams 750 illustrating example communications between the UE 502 and the base station 504. As illustrated in FIG. 7B, the base station 504 may transmit a DCI 1_1 with TCI Indication (M,N)=(2,2) 752. Two SRS resource sets may be selected by DCI 0_1 for TRP 1, DCI 0_1 for TRP 1 and TRP 2, or DCI 0_1 for TRP 2.

In some aspects, S-TRP or M-TRP operation may be switched by number of TCIs in the TCI indication field in DCI 1_1 or DCI 1_2. In some aspects, a DCI 1_1 or DCI 1_2 indicating a single TCI may enable S-TRP PUSCH transmission after TCI indication takes effect. A TCI may be configured to be associated with one of two SRS resource sets. For DCI 0_1 or DCI 0_2 configured with two fields of SRI/TPMI/TPC, one selected field may be used. In some aspects, a DCI 1_1/1_2 indicating two TCIs may enable M-TRP PUSCH transmission after TCI indication takes effect. Two TCIs in one TCI codepoint may be configured to be associated with two SRS resource sets, respectively. For DCI 0_1/0_2 configured with two fields of SRI/TPMI/TPC, both fields may be used for different TRPs. The DCI 0_1/0_2 may or may not be configured with dynamic switch field. If configured, the indication of dynamic switch field may be consistent to the TCI indication.

In some aspects, S-TRP or M-TRP operation may be switched by the dynamic switching field in DCI 0_1/0_2 when 2 TCIs are indicated in the TCI indication field in DCI 1_1/1_2. In some aspects, the DCI 0_1/0_2 configured with a dynamic switch field may switch the S-TRP or M-TRP operation after TCI indication takes effect. In some aspects, when 1 TCI is indicated in the TCI indication field in DCI 1_1/1_2, no more than S-TRP operation may be enabled. In some aspects, for DCI 0_1/0_2 configured with two fields of SRI/TPMI/TPC, one selected field may be used.

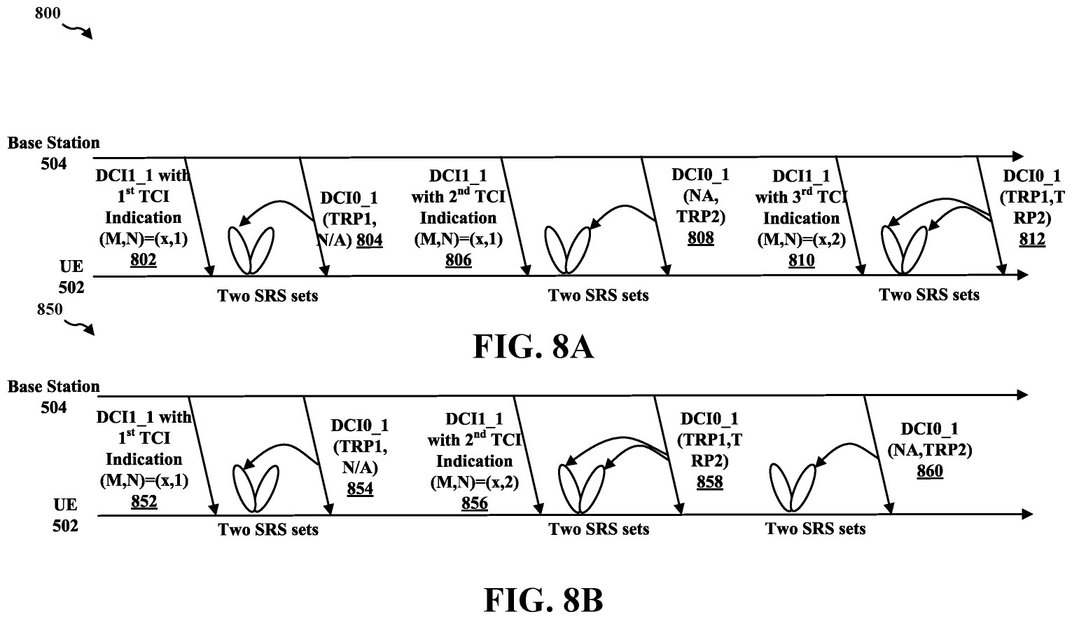

FIGS. 8A and 8B are diagrams 800 and 850 illustrating example communications between a UE and a base station. As illustrated in FIG. 8A, the base station 504 may transmit DCI 1_1 with first TCI indication (M,N)=(x,1) 802 to the UE 502. The base station 504 may further transmit a DCI 0_1 with some field as (TRP 1, NA) 804 associated with two SRS resource sets to the UE 502, which schedule a UL transmission for TRP 1 only using the indicated TCI in the first TCI indication 802. The base station 504 may further transmit a DCI 1_1 with second TCI indication (M,N)=(x,1) 806 to the UE 502. The base station 504 may further transmit a DCI 0_1 with some field as (TRP 2, NA) 808 associated with two SRS resource sets to the UE 502, which schedule a UL transmission for TRP 2 using the indicated TCI in the second TCI indication 806. The base station 504 may further transmit a DCI 1_1 with third TCI indication (M,N)=(x,2) 810 associated to the UE 502. The base station 504 may further transmit a DCI 0_1 with field as (TRP 1, TRP 2) 812 associated with two SRS resource sets to the UE 502, which schedule a UL transmission for TRP 1 and TRP2 using two indicated TCIs in the third TCI indication 810.

As illustrated in FIG. 8B, the base station 504 may transmit DCI 1_1 with first TCI Indication (M,N)=(x,1) 852 to the UE 502. The base station 504 may further transmit a DCI 0_1 with dynamic switching field as (TRP 1, NA) 854 associated with two SRS resource sets to the UE 502, which schedule a UL transmission for TRP 1. The base station 504 may further transmit a DCI 1_1 with second TCI indication (M,N)=(x,2) 856 to the UE 502. The base station 504 may further transmit a DCI 0_1 with dynamic switching field as (TRP 1, TRP 2) 858 associated with two SRS resource sets to the UE 502, which schedule a UL transmission for TRP 1 and TRP 2. The base station 504 may further transmit a DCI 0_1 with dynamic switching field as (N/A, TRP 2) 860 associated with two SRS resource sets to the UE 502, which schedule a UL transmission for TRP 2.

In some aspects, when the UE 502 is indicated with a TCI codepoint of joint TCI with (M,N)=(2, 2), or separate TCI(s) with (M,N)=(1,2) or (2,2), the UE 502 may apply the indicated unified TCIs to a M-TRP PUCCH transmission with repetitions. In some aspects, the TCI indication field in DCI 1_1/1_2 may switch between S-TRP and M-TRP PUCCH operation. In some aspects, a DCI 1_1/1_2 indicating a single TCI may enable a S-TRP PUCCH transmission where the PUCCH is transmitted without repetition and a single TCI indicated is applied to the PUCCH. In some aspects, after TCI indication takes effect, for DCI 1_1/1_2 configured with two TPC fields, one selected field may be used. In some aspects, a DCI 1_1/1_2 indicating two TCIs may enable a M-TRP PUCCH transmission if the set of PC parameters is associated with the TCI for PUCCH, after the TCI indication takes effect. In some aspects, if DCI 1_1/1_2 has two TPC fields, and if two TCIs are associated with different “closedLoopIndex” value, two TPC fields may be used for different TRPs. In some aspects, if DCI 1_1/1_2 has two TPC fields, and if two TCIs are associated with one “closedLoopIndex” value, the TPC field for the “closedLoopIndex” value may be used for PUSCH, and the other TPC field associated with the other “closedLoopIndex” value may be unused. In some aspects, for DCI 1_0 of single TPC field, no more than one TPC field may be applied to both close loop index(es) of the PUCCH. The table below may provide a summary for S-TRP and M-TRP UL operations.

TABLE 3

| | | | | UL M- |
|---|---|---|---|---|
| TCI Indication | | UL M-TRP | | TRP |
| configurations | UL S-TRP PUSCH | PUSCH | UL S-TRP PUCCH | PUCCH |
| Configuration1: | Applicable if dynamic | Applicable | Not Applicable | Applicable |
| Only one latest | switch field is | | | |
| TCI indication | configured | | | |
| is valid, and the | | | | |
| one TCI | | | | |
| indication may | | | | |
| be (M = x, N = 2) | | | | |
| Configuration2: | Applicable | Not Applicable | Applicable | Not |
| Only one latest | | | | Applicable |
| TCI indication | | | | |
| is valid, and the | | | | |
| one TCI | | | | |
| indication may | | | | |
| be (M = x, N = 1) | | | | |
| Configuration3: | Applicable when | Applicable when | Applicable when | Applicable |
| Only one latest | single-TCI | two-TCI | single-TCI | when two- |
| TCI indication | | | | TCI |
| is valid, and the | | | | |
| one TCI | | | | |
| indication may | | | | |
| be (M = x, N = 2) | | | | |
| or (M = x, N = 1) | | | | |
| Configuration2: | Applicable | Applicable if | Applicable | Not |
| Multiple TCI | | dynamic switch | | Applicable |
| indication can | | field is configured | | |
| be valid and | | | | |
| applied for | | | | |
| different set of | | | | |
| channels, and | | | | |
| each TCI | | | | |
| indication may | | | | |
| be (M = x, N = 1) | | | | |

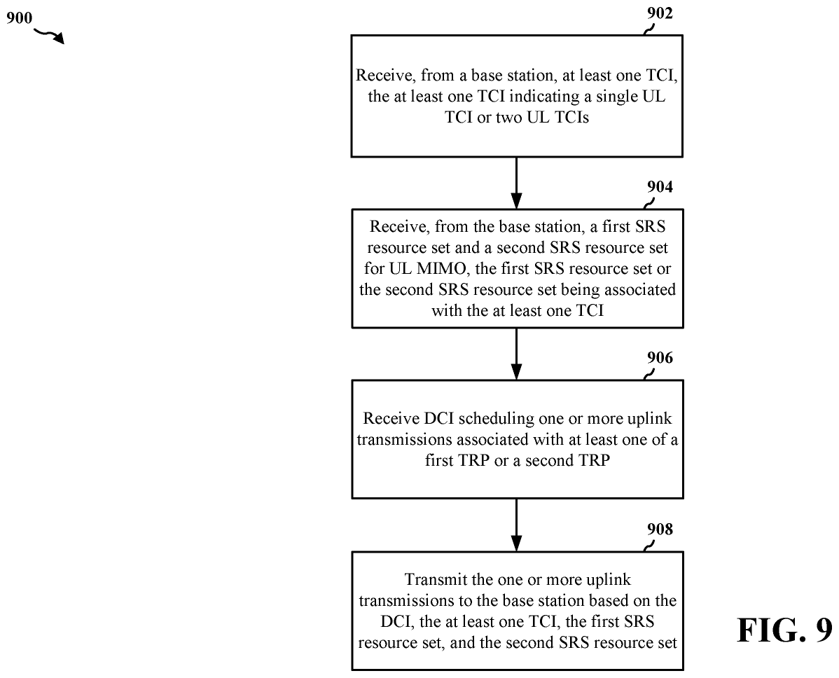

FIG. 9 is a flowchart 900 of a method of wireless communication. The method may be performed by a UE (e.g., the UE 94, the UE 502; the apparatus 1102). The method may be used for improving UL communications with UL TCI.

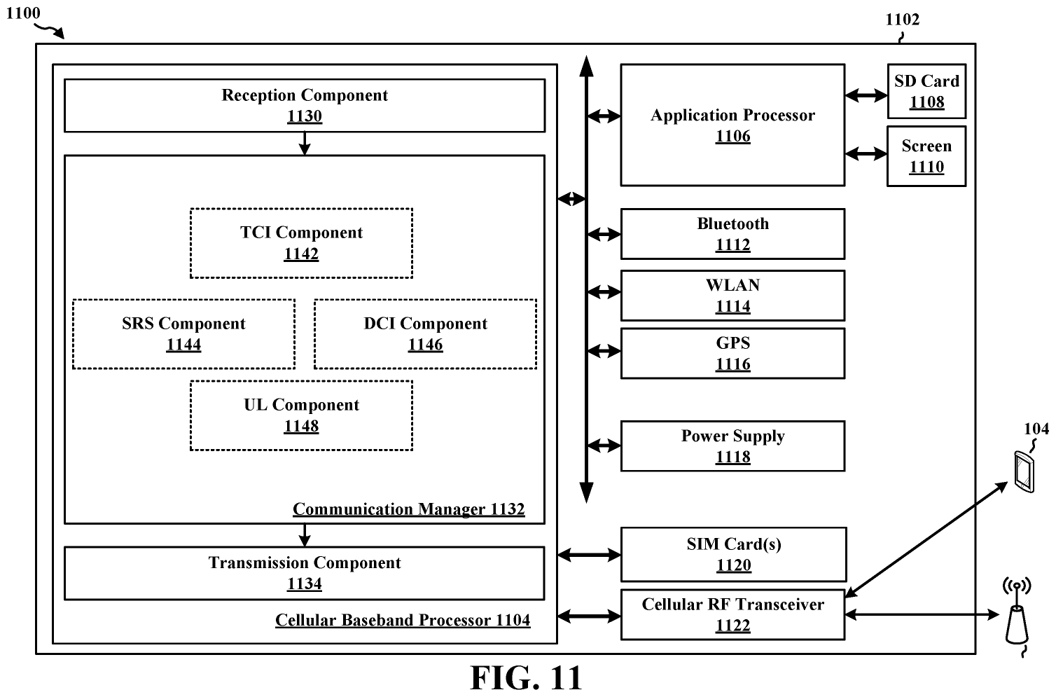

At 902, the UE may receive, from a base station, at least one TCI, the at least one TCI indicating a single UL TCI or two UL TCIs. For example, the UE 502 may receive, from a base station 504, at least one TCI (e.g., in TCI indication 506), the at least one TCI indicating a single UL TCI or two UL TCIs. In some aspects, 902 may be performed by TCI component 1142 in FIG. 11.

At 904, the UE may receive, from the base station, a first SRS resource set and a second SRS resource set for UL MIMO, the first SRS resource set or the second SRS resource set being associated with the at least one TCI. For example, the UE 502 may receive, from the base station 504, a first SRS resource set and a second SRS resource set for UL MIMO (e.g., indicated by DCI 508), the first SRS resource set or the second SRS resource set being associated with the at least one TCI. In some aspects, 904 may be performed by SRS component 1144 in FIG. 11.

At 906, the UE may receive DCI scheduling one or more uplink transmissions associated with at least one of a first TRP or a second TRP. For example, the UE 502 may receive DCI 508 scheduling one or more uplink transmissions associated with at least one of a first TRP or a second TRP. In some aspects, 906 may be performed by DCI component 1146 in FIG. 11.

At 908, the UE may transmit the one or more uplink transmissions to the base station based on the DCI, the at least one TCI, the first SRS resource set, and the second SRS resource set. For example, the UE 502 may transmit the one or more uplink transmissions (e.g., the PUCCH/PUSCH 512) to the base station 504 based on the DCI, the at least one TCI, the first SRS resource set, and the second SRS resource set. In some aspects, 908 may be performed by UL component 1148 in FIG. 11.

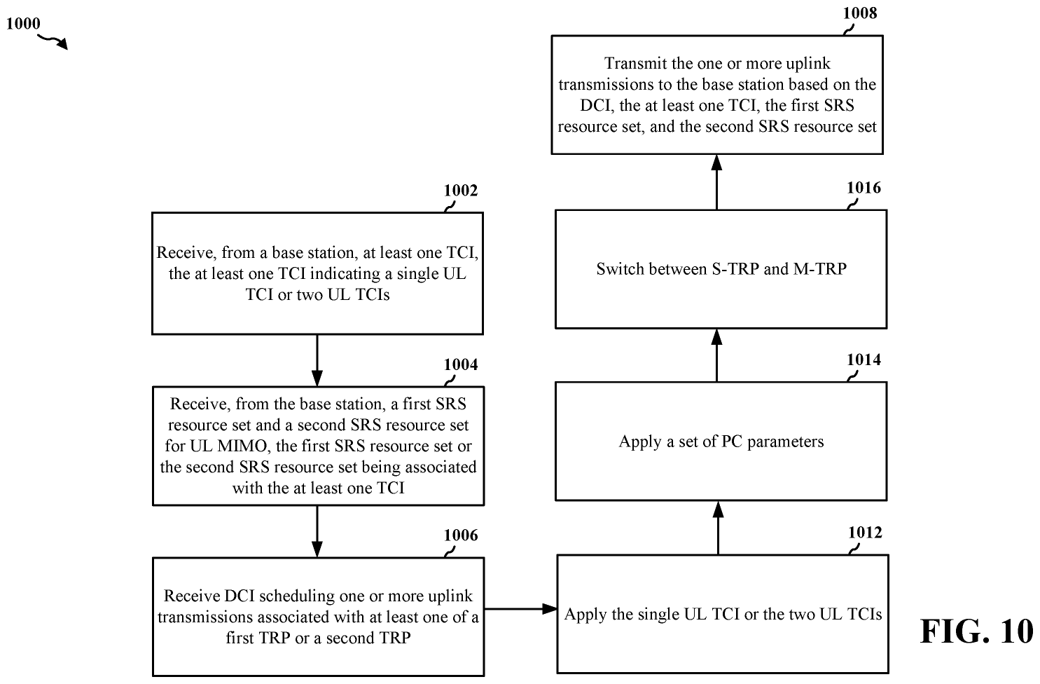

FIG. 10 is a flowchart 1000 of a method of wireless communication. The method may be performed by a UE (e.g., the UE 104, the UE 502; the apparatus 1102). The method may be used for improving UL communications with UL TCI.

At 1002, the UE may receive, from a base station, at least one TCI, the at least one TCI indicating a single UL TCI or two UL TCIs. For example, the UE 502 may receive, from a base station 504, at least one TCI (e.g., in TCI indication 506), the at least one TCI indicating a single UL TCI or two UL TCIs. In some aspects, 1002 may be performed by TCI component 1142 in FIG. 11.

At 1004, the UE may receive, from the base station, a first SRS resource set and a second SRS resource set for UL MIMO, the first SRS resource set or the second SRS resource set being associated with the at least one TCI. For example, the UE 502 may receive, from the base station 504, a first SRS resource set and a second SRS resource set for UL MIMO (e.g., indicated by DCI 508), the first SRS resource set or the second SRS resource set being associated with the at least one TCI. In some aspects, 1004 may be performed by SRS component 1144 in FIG. 11. In some aspects, the UL MIMO may be one of a codebook based MIMO or a non-codebook based MIMO.

At 1006, the UE may receive DCI scheduling one or more uplink transmissions associated with at least one of a first TRP or a second TRP. For example, the UE 502 may receive DCI 508 scheduling one or more uplink transmissions associated with at least one of a first TRP or a second TRP. In some aspects, 1006 may be performed by DCI component 1146 in FIG. 11.

At 1012, the UE may apply the single UL TCI or the two UL TCIs. For example, the UE 502 may apply the single UL TCI or the two UL TCIs. In some aspects, 1012 may be performed by UL component 1148 in FIG. 11. In some aspects, the at least one TCI may indicate the single UL TCI. In some aspects, the UE may apply the single UL TCI to the first SRS resource set and the second SRS resource set. In some aspects, to apply the single UL TCI, UE may apply at least one default SRS resource set of the first SRS resource set and the second SRS resource set. In some aspects, the at least one TCI may indicate the single UL TCI, where the at least one TCI may be a joint TCI or two separate TCIs. In some aspects, the UE may apply the single UL TCI to an associated SRS resource set of the first SRS resource set or the second SRS resource set based on an association. In some aspects, the at least one TCI may indicate the two UL TCIs, where the at least one TCI may be a joint TCI or two separate TCIs. In some aspects, the UE may apply the two UL TCIs to associated SRS resource sets of the first SRS resource set or the second SRS resource set based on an association. In some aspects, the UE may respectively apply the two UL TCIs to the first SRS resource set and the second SRS resource set.

At 1014, the UE may apply a set of PC parameters. For example, the UE 502 may apply a set of PC parameters. In some aspects, 1014 may be performed by UL component 1148 in FIG. 11. In some aspects, the UE may apply a set of PC parameters associated with the single UL TCI to a PUSCH or a PUCCH based on the DCI may be associated with the single UL TCI or a dynamic switching. In some aspects, the UE may apply a set of power control parameters associated with the single UL TCI to a PUSCH. In some aspects, the association may be based on a RRC or MAC-CE from the base station. In some aspects, the UE may suspend a non-associated SRS resource set of the second SRS resource set or the first SRS resource set based on the association. In some aspects, apply a set of PC parameters associated with the single UL TCI to a PUSCH or a PUCCH based on the DCI may be associated with the single UL TCI or a dynamic switching. In some aspects, the association may be based on a RRC or MAC-CE from the base station. In some aspects, the at least one TCI may indicate the two UL TCIs, the at least one TCI may be a joint TCI or two separate TCIs, and the DCI may be configured with two TPC fields associated with the two UL TCIs. In some aspects, the two UL TCIs are associated with a same closed loop index, and the UE may be configured to apply one TPC field of the two TPC fields after one of the two UL TCIs takes effect.

At 1016, the UE may switch between S-TRP and M-TRP. For example, the UE 502 may switch between S-TRP and M-TRP. In some aspects, 1016 may be performed by UL component 1148 in FIG. 11. In some aspects, the UE may switch between S-TRP and M-TRP based on a dynamic switching indicated in the DCI. In some aspects, the dynamic switching indicated in the DCI may indicate the S-TRP for a PUSCH and one SRS resource set of the first SRS resource set and the second SRS resource set. In some aspects, the dynamic switching indicated in the DCI may indicate the M-TRP for a PUSCH and an order associated with the first SRS resource set and the second SRS resource set. In some aspects, the dynamic switching indicated in the DCI may indicate the M-TRP for a PUSCH, and a lowest ID TCI of the two UL TCIs may be used. In some aspects, the UE may switch between S-TRP and M-TRP based on a number of TCIs indicated in the DCI. In some aspects, the UE may switch between S-TRP and M-TRP for a PUCCH. In some aspects, the UE may switch between S-TRP and M-TRP for a PUCCH based on a number of TCIs indicated in the DCI.

At 1008, the UE may transmit the one or more uplink transmissions to the base station based on the DCI, the at least one TCI, the first SRS resource set, and the second SRS resource set. For example, the UE 502 may transmit the one or more uplink transmissions (e.g., the PUCCH/PUSCH 512) to the base station 504 based on the DCI, the at least one TCI, the first SRS resource set, and the second SRS resource set. In some aspects, 1008 may be performed by UL component 1148 in FIG. 11. In some aspects, the UE may support a DCI format 0_1 and a DCI format 0_2 with dynamic switching selecting the first SRS resource set or the second SRS resource set for a S-TRP PUSCH transmission. In some aspects, the first SRS resource set may be associated with a first precoder and the second SRS resource set may be associated with a second precoder. In some aspects, the UE may support a DCI format 0_1 and a DCI format 02 with dynamic switching selecting the first SRS resource set or the second SRS resource set for a M-TRP with precoder cycling associated with the first SRS resource set and the second SRS resource set. In some aspects, the UE may support a DCI format 0_1 and a DCI format 0_2 with dynamic switching selecting one or more of the first SRS resource set or the second SRS resource set for a S-TRP PUSCH transmission or a M-TRP PUSCH transmission. In some aspects, the dynamic switching may indicate an order of the first SRS resource set or the second SRS resource set and an order of the two UL TCIs.

FIG. 11 is a diagram 1100 illustrating an example of a hardware implementation for an apparatus 1102. The apparatus 1102 may be a UE, a component of a UE, or may implement UE functionality. In some aspects, the apparatus 1102 may include a cellular baseband processor 1104 (also referred to as a modem) coupled to a cellular RF transceiver 1122. In some aspects, the apparatus 1102 may further include one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, or a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the additional modules of the apparatus 1102.

The communication manager 1132 may include a TCI component 1142 that is configured to receive, from a base station, at least one TCI, the at least one TCI indicating a single UL TCI or two UL TCIs, e.g., as described in connection with 902 in FIG. 9 or 1002 in FIG. 10 The communication manager 1132 may further include an SRS component 1144 that may be configured to receive, from the base station, a first SRS resource set and a second SRS resource set for UL MIMO, the first SRS resource set or the second SRS resource set being associated with the at least one TCI, e.g., as described in connection with 904 in FIG. 9 or 1004 in FIG. 10. The communication manager 1132 may further include a DCI component 1146 that may be configured to receive DCI scheduling one or more uplink transmissions associated with at least one of a first TRP or a second TRP, e.g., as described in connection with 906 in FIG. 9 or 1006 in FIG. 10. The communication manager 1132 may further include a UL component 1148 that may be configured to transmit the one or more uplink transmissions to the base station based on the DCI, the at least one TCI, the first SRS resource set, and the second SRS resource set, e.g., as described in connection with 908 in FIG. 9 or 1008 in FIG. 10. The UL component 1148 may be further configured to apply the single UL TCI or the two UL TCIs, switch between S-TRP and M-TRP, or switch between S-TRP and M-TRP, e.g., as described in 1012, 1014, or 1016 in FIG. 10.

The apparatus may include additional components that perform each of the blocks of the algorithm in the flowcharts of FIGS. 9-10. As such, each block in the flowcharts of FIGS. 9-10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1102 may include a variety of components configured for various functions. In one configuration, the apparatus 1102, and in particular the cellular baseband processor 1104, may include means for receiving, from a base station, at least one TCI, the at least one TCI indicating a single UL TCI or two UL TCIs. The cellular baseband processor 1104 may further include means for receiving, from the base station, a first SRS resource set and a second SRS resource set for UL MIMO, the first SRS resource set or the second SRS resource set being associated with the at least one TCI. The cellular baseband processor 1104 may further include means for receiving DCI scheduling one or more uplink transmissions associated with at least one of a first TRP or a second TRP. The cellular baseband processor 1104 may further include means for transmitting the one or more uplink transmissions to the base station based on the DCI, the at least one TCI, the first SRS resource set, and the second SRS resource set. The cellular baseband processor 1104 may further include means for applying the single UL TCI to the first SRS resource set and the second SRS resource set. The cellular baseband processor 1104 may further include means for applying a set of PC parameters associated with the single UL TCI to a PUSCH or a PUCCH based on the DCI being associated with the single UL TCI or a dynamic switching. The cellular baseband processor 1104 may further include means for applying the single UL TCI to an associated SRS resource set of the first SRS resource set or the second SRS resource set based on an association. The cellular baseband processor 1104 may further include means for applying a set of PC parameters associated with the single UL TCI to a PUSCH or a PUCCH based on the DCI being associated with the single UL TCI or a dynamic switching. The cellular baseband processor 1104 may further include means for applying a set of power control parameters associated with the single UL TCI to a PUSCH. The cellular baseband processor 1104 may further include means for suspending a non-associated SRS resource set of the second SRS resource set or the first SRS resource set based on the association. The cellular baseband processor 1104 may further include means for applying the two UL TCIs to associated SRS resource sets of the first SRS resource set or the second SRS resource set based on an association. The cellular baseband processor 1104 may further include means for applying a set of PC parameters associated with the single UL TCI to a PUSCH or a PUCCH based on the DCI being associated with the single UL TCI or a dynamic switching. The cellular baseband processor 1104 may further include means for respectively applying the two UL TCIs to the first SRS resource set and the second SRS resource set. The cellular baseband processor 1104 may further include means for switching between S-TRP and M-TRP based on a dynamic switching indicated in the DCI. The cellular baseband processor 1104 may further include means for switching between S-TRP and M-TRP based on a number of TCIs indicated in the DCI. The cellular baseband processor 1104 may further include means for switching between S-TRP and M-TRP for a PUCCH. The cellular baseband processor 1104 may further include means for switching between S-TRP and M-TRP for a PUCCH based on a number of TCIs indicated in the DCI. The means may be one or more of the components of the apparatus 1102 configured to perform the functions recited by the means. As described supra, the apparatus 1102 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE, comprising: a memory; and at least one processor coupled to the memory and configured to: receive, from a base station, at least one TCI, the at least one TCI indicating a single UL TCI or two UL TCIs; receive, from the base station, a first SRS resource set and a second SRS resource set for UL MIMO, the first SRS resource set or the second SRS resource set being associated with the at least one TCI; receive DCI scheduling one or more uplink transmissions associated with at least one of a first TRP or a second TRP; and transmit the one or more uplink transmissions to the base station based on the DCI, the at least one TCI, the first SRS resource set, and the second SRS resource set.

Aspect 2 is the apparatus of aspect 1, wherein the at least one TCI indicates the single UL TCI, and wherein the at least one processor coupled to the memory is further configured to: apply the single UL TCI to the first SRS resource set and the second SRS resource set.

Aspect 3 is the apparatus of any of aspects 1-2, wherein the at least one processor coupled to the memory is further configured to: apply a set of PC parameters associated with the single UL TCI to a PUSCH or a PUCCH based on the DCI being associated with the single UL TCI or a dynamic switching.

Aspect 4 is the apparatus of any of aspects 1-3, wherein the UE supports a DCI format 0_1 and a DCI format 0_2 with dynamic switching selecting the first SRS resource set or the second SRS resource set for a S-TRP PUSCH transmission, and wherein the first SRS resource set is associated with a first precoder and the second SRS resource set is associated with a second precoder.

Aspect 5 is the apparatus of any of aspects 1-4, wherein the UE supports a DCI format 0_1 and a DCI format 0_2 with dynamic switching selecting the first SRS resource set or the second SRS resource set for a M-TRP with precoder cycling associated with the first SRS resource set and the second SRS resource set.

Aspect 6 is the apparatus of any of aspects 1-5, wherein to apply the single UL TCI, the at least one processor is configured to apply at least one default SRS resource set of the first SRS resource set and the second SRS resource set.

Aspect 7 is the apparatus of any of aspects 1-6, wherein the at least one TCI indicates the single UL TCI, wherein the at least one TCI is a joint TCI or two separate TCIs, and wherein the at least one processor coupled to the memory is further configured to: apply the single UL TCI to an associated SRS resource set of the first SRS resource set or the second SRS resource set based on an association.

Aspect 8 is the apparatus of any of aspects 1-7, wherein the at least one processor coupled to the memory is further configured to: apply a set of PC parameters associated with the single UL TCI to a PUSCH or a PUCCH based on the DCI being associated with the single UL TCI or a dynamic switching.

Aspect 9 is the apparatus of any of aspects 1-8, wherein the at least one processor coupled to the memory is further configured to: apply a set of power control parameters associated with the single UL TCI to a PUSCH.

Aspect 10 is the apparatus of any of aspects 1-9, wherein the association is based on a RRC or MAC-CE from the base station.

Aspect 11 is the apparatus of any of aspects 1-10, wherein the at least one processor coupled to the memory is further configured to: suspend a non-associated SRS resource set of the second SRS resource set or the first SRS resource set based on the association.

Aspect 12 is the apparatus of any of aspects 1-11, wherein the at least one TCI indicates the two UL TCIs, wherein the at least one TCI is a joint TCI or two separate TCIs, and wherein the at least one processor coupled to the memory is further configured to: apply the two UL TCIs to associated SRS resource sets of the first SRS resource set or the second SRS resource set based on an association.

Aspect 13 is the apparatus of any of aspects 1-12, wherein the at least one processor coupled to the memory is further configured to: apply a set of PC parameters associated with the single UL TCI to a PUSCH or a PUCCH based on the DCI being associated with the single UL TCI or a dynamic switching.

Aspect 14 is the apparatus of any of aspects 1-13, wherein the association is based on a RRC or MAC-CE from the base station.

Aspect 15 is the apparatus of any of aspects 1-14, wherein the UE supports a DCI format 0_1 and a DCI format 0_2 with dynamic switching selecting one or more of the first SRS resource set or the second SRS resource set for a S-TRP PUSCH transmission or a M-TRP PUSCH transmission.

Aspect 16 is the apparatus of any of aspects 1-15, wherein the dynamic switching indicates an order of the first SRS resource set or the second SRS resource set and an order of the two UL TCIs.

Aspect 17 is the apparatus of any of aspects 1-16, wherein the at least one TCI indicates the two UL TCIs, wherein the at least one TCI is a joint TCI or two separate TCIs, and wherein the DCI is configured with two TPC fields associated with the two UL TCIs.

Aspect 18 is the apparatus of any of aspects 1-17, wherein the two UL TCIs are associated with a same closed loop index, and wherein the UE is configured to apply one TPC field of the two TPC fields after one of the two UL TCIs takes effect.

Aspect 19 is the apparatus of any of aspects 1-18, wherein the UL MIMO is one of a codebook based MIMO or a non-codebook based MIMO, and wherein the at least one processor coupled to the memory is further configured to: respectively apply the two UL TCIs to the first SRS resource set and the second SRS resource set.

Aspect 20 is the apparatus of any of aspects 1-19, wherein the at least one processor coupled to the memory is further configured to: switch between S-TRP and M-TRP based on a dynamic switching indicated in the DCI.

Aspect 21 is the apparatus of any of aspects 1-20, wherein the dynamic switching indicated in the DCI indicates the S-TRP for a PUSCH and one SRS resource set of the first SRS resource set and the second SRS resource set.

Aspect 22 is the apparatus of any of aspects 1-21, wherein the dynamic switching indicated in the DCI indicates the M-TRP for a PUSCH and an order associated with the first SRS resource set and the second SRS resource set.

Aspect 23 is the apparatus of any of aspects 1-22, wherein the dynamic switching indicated in the DCI indicates the M-TRP for a PUSCH, and wherein a lowest ID TCI of the two UL TCIs is used.

Aspect 24 is the apparatus of any of aspects 1-23, wherein the at least one processor coupled to the memory is further configured to: switch between S-TRP and M-TRP based on a number of TCIs indicated in the DCI.

Aspect 25 is the apparatus of any of aspects 1-24, wherein the at least one processor coupled to the memory is further configured to: switch between S-TRP and M-TRP for a PUCCH.

Aspect 26 is the apparatus of any of aspects 1-25, wherein the at least one processor coupled to the memory is further configured to: switch between S-TRP and M-TRP for a PUCCH based on a number of TCIs indicated in the DCI.

Aspect 27 is the apparatus of any of aspects 1-26, further comprising a transceiver coupled to the at least one processor.

Aspect 28 is a method of wireless communication for implementing any of aspects 1 to 27.

Aspect 29 is an apparatus for wireless communication including means for implementing any of aspects 1 to 27.

Aspect 30 is a computer-readable medium storing computer executable code, where the code when executed by a processor causes the processor to implement any of aspects 1 to 27.

What is claimed is:

1. An apparatus for wireless communication at a user equipment (UE), comprising:
a memory; and
at least one processor coupled to the memory and configured to:
receive, from a base station, at least one transmission configuration indicator (TCI), the at least one TCI indicating a single uplink (UL) TCI or two UL TCIs;
receive, from the base station, a first sounding reference signal (SRS) resource set and a second SRS resource set for UL multiple input multiple output (MIMO), the first SRS resource set or the second SRS resource set being associated with the at least one TCI;
receive downlink control information (DCI) scheduling one or more uplink transmissions associated with at least one of a first transmission reception point (TRP) or a second TRP; and
transmit the one or more uplink transmissions to the base station based on the DCI, the at least one TCI, the first SRS resource set, and the second SRS resource set.

2. The apparatus of claim 1, wherein the at least one TCI indicates the single UL TCI, and wherein the at least one processor coupled to the memory is further configured to:
apply the single UL TCI to the first SRS resource set and the second SRS resource set.

3. The apparatus of claim 2, wherein the at least one processor coupled to the memory is further configured to:
apply a set of power control (PC) parameters associated with the single UL TCI to a physical uplink shared channel (PUSCH) or a physical uplink control channel (PUCCH) based on the DCI being associated with the single UL TCI or a dynamic switching.

4. The apparatus of claim 2, wherein the UE supports a DCI format 0_1 and a DCI format 0_2 with dynamic switching selecting the first SRS resource set or the second SRS resource set for a single transmission reception point (S-TRP) physical uplink shared channel (PUSCH) transmission, and wherein the first SRS resource set is associated with a first precoder and the second SRS resource set is associated with a second precoder.

5. The apparatus of claim 2, wherein the UE supports a DCI format 0_1 and a DCI format 0_2 with dynamic switching selecting the first SRS resource set or the second SRS resource set for a multiple transmission reception point (M-TRP) with precoder cycling associated with the first SRS resource set and the second SRS resource set.

6. The apparatus of claim 2, wherein to apply the single UL TCI, the at least one processor is configured to apply at least one default SRS resource set of the first SRS resource set and the second SRS resource set.

7. The apparatus of claim 1, wherein the at least one TCI indicates the single UL TCI, wherein the at least one TCI is a joint TCI or two separate TCIs, and wherein the at least one processor coupled to the memory is further configured to:
apply the single UL TCI to an associated SRS resource set of the first SRS resource set or the second SRS resource set based on an association.

8. The apparatus of claim 7, wherein the at least one processor coupled to the memory is further configured to:
apply a set of power control (PC) parameters associated with the single UL TCI to a physical uplink shared channel (PUSCH) or a physical uplink control channel (PUCCH) based on the DCI being associated with the single UL TCI or a dynamic switching.

9. The apparatus of claim 7, wherein the at least one processor coupled to the memory is further configured to:
apply a set of power control parameters associated with the single UL TCI to a physical uplink shared channel (PUSCH).

10. The apparatus of claim 7, wherein the association is based on a radio resource control (RRC) or medium access control (MAC) control element (CE) (MAC-CE) from the base station.

11. The apparatus of claim 7, wherein the at least one processor coupled to the memory is further configured to:
suspend a non-associated SRS resource set of the second SRS resource set or the first SRS resource set based on the association.

12. The apparatus of claim 1, wherein the at least one TCI indicates the two UL TCIs, wherein the at least one TCI is a joint TCI or two separate TCIs, and wherein the at least one processor coupled to the memory is further configured to:
apply the two UL TCIs to associated SRS resource sets of the first SRS resource set or the second SRS resource set based on an association.

13. The apparatus of claim 12, wherein the at least one processor coupled to the memory is further configured to:
apply a set of power control (PC) parameters associated with the single UL TCI to a physical uplink shared channel (PUSCH) or a physical uplink control channel (PUCCH) based on the DCI being associated with the single UL TCI or a dynamic switching.

14. The apparatus of claim 12, wherein the association is based on a radio resource control (RRC) or medium access control (MAC) control element (CE) (MAC-CE) from the base station.

15. The apparatus of claim 12, wherein the UE supports a DCI format 0_1 and a DCI format 0_2 with dynamic switching selecting one or more of the first SRS resource set or the second SRS resource set for a single transmission reception point (S-TRP) physical uplink shared channel (PUSCH) transmission or a multiple transmission reception point (M-TRP) PUSCH transmission.

16. The apparatus of claim 15, wherein the dynamic switching indicates an order of the first SRS resource set or the second SRS resource set and an order of the two UL TCIs.

17. The apparatus of claim 1, wherein the at least one TCI indicates the two UL TCIs, wherein the at least one TCI is a joint TCI or two separate TCIs, and wherein the DCI is configured with two transmit power control (TPC) fields associated with the two UL TCIs.

18. The apparatus of claim 17, wherein the two UL TCIs are associated with a same closed loop index, and wherein the UE is configured to apply one TPC field of the two TPC fields after one of the two UL TCIs takes effect.

19. The apparatus of claim 17, wherein the UL MIMO is one of a codebook based MIMO or a non-codebook based MIMO, and wherein the at least one processor coupled to the memory is further configured to:
respectively apply the two UL TCIs to the first SRS resource set and the second SRS resource set.

20. The apparatus of claim 19, wherein the at least one processor coupled to the memory is further configured to:
switch between single transmission reception point (S-TRP) and multiple transmission reception point (M-TRP) based on a dynamic switching indicated in the DCI.

21. The apparatus of claim 20, wherein the dynamic switching indicated in the DCI indicates the S-TRP for a physical uplink shared channel (PUSCH) and one SRS resource set of the first SRS resource set and the second SRS resource set.

22. The apparatus of claim 20, wherein the dynamic switching indicated in the DCI indicates the M-TRP for a physical uplink shared channel (PUSCH) and an order associated with the first SRS resource set and the second SRS resource set.

23. The apparatus of claim 20, wherein the dynamic switching indicated in the DCI indicates the M-TRP for a physical uplink shared channel (PUSCH), and wherein a lowest identifier (ID) TCI of the two UL TCIs is used.

24. The apparatus of claim 19, wherein the at least one processor coupled to the memory is further configured to:
switch between single transmission reception point (S-TRP) and multiple transmission reception point (M-TRP) based on a number of TCIs indicated in the DCI.

25. The apparatus of claim 19, wherein the at least one processor coupled to the memory is further configured to:
switch between single transmission reception point (S-TRP) and multiple transmission reception point (M-TRP) for a physical uplink control channel (PUCCH).

26. The apparatus of claim 25, wherein the at least one processor coupled to the memory is further configured to:
switch between single transmission reception point (S-TRP) and multiple transmission reception point (M-TRP) for a physical uplink control channel (PUCCH) based on a number of TCIs indicated in the DCI.

27. The apparatus of claim 1, further comprising a transceiver coupled to the at least one processor.

28. A method of wireless communication at a user equipment (UE), comprising:
receiving, from a base station, at least one transmission configuration indicator (TCI), the at least one TCI indicating a single uplink (UL) TCI or two UL TCIs;
receiving, from the base station, a first sounding reference signal (SRS) resource set and a second SRS resource set for UL multiple input multiple output (MIMO), the first SRS resource set or the second SRS resource set being associated with the at least one TCI;
receiving downlink control information (DCI) scheduling one or more uplink transmissions associated with at least one of a first transmission reception point (TRP) or a second TRP; and
transmitting the one or more uplink transmissions to the base station based on the DCI, the at least one TCI, the first SRS resource set, and the second SRS resource set.

29. An apparatus for wireless communication at a user equipment (UE), comprising:
means for receiving, from a base station, at least one transmission configuration indicator (TCI), the at least one TCI indicating a single uplink (UL) TCI or two UL TCIs;
means for receiving, from the base station, a first sounding reference signal (SRS) resource set and a second SRS resource set for UL multiple input multiple output (MIMO), the first SRS resource set or the second SRS resource set being associated with the at least one TCI;
means for receiving downlink control information (DCI) scheduling one or more uplink transmissions associated with at least one of a first transmission reception point (TRP) or a second TRP; and
means for transmitting the one or more uplink transmissions to the base station based on the DCI, the at least one TCI, the first SRS resource set, and the second SRS resource set.

30. A computer-readable medium storing computer executable code at a user equipment (UE), the code when executed by a processor causes the processor to:
receive, from a base station, at least one transmission configuration indicator (TCI), the at least one TCI indicating a single uplink (UL) TCI or two UL TCIs;
receive, from the base station, a first sounding reference signal (SRS) resource set and a second SRS resource set for UL multiple input multiple output (MIMO), the first SRS resource set or the second SRS resource set being associated with the at least one TCI;
receive downlink control information (DCI) scheduling one or more uplink transmissions associated with at least one of a first transmission reception point (TRP) or a second TRP; and
transmit the one or more uplink transmissions to the base station based on the DCI, the at least one TCI, the first SRS resource set, and the second SRS resource set.
